(19) United States
(12) Patent Application Publication
(10) Pub. No.: US 2025/0183690 A1
(43) Pub. Date: Jun. 5, 2025

(54) CHARGING CONTROL SYSTEM OF A CHARGING UNIT FOR BATTERY PACKS

(71) Applicant: Caterpillar Inc., Peoria, IL (US)

(72) Inventors: Bryan Anthony JOHNSON, Montgomery, IL (US); Mitchel R. DECKARD, Montgomery, TX (US)

(73) Assignee: Caterpillar Inc., Peoria, IL (US)

(21) Appl. No.: 18/525,043

(22) Filed: Nov. 30, 2023

(51) Int. Cl. H02J 7/00; H01M 10/42; H01M 10/44

(52) U.S. Cl. CPC H02J 7/00712; H01M 10/425; H01M 10/44; H02J 7/00032; H02J 7/0042; H02J 7/0048; H02J 7/005; H01M 2010/4271

(57) ABSTRACT

A controller may receive, prior to initiation of charging of a battery pack by a charging unit, charging information relating to the battery pack. The controller may identify, in accordance with a comparison of the charging information to charging guidelines, whether charging the battery pack is to comply with the charging guidelines. The controller may output, responsive to identifying that charging the battery pack is to violate the charging guidelines, a request for an operator input to indicate whether charging the battery pack is to be initiated. The controller may cause initiation of charging of the battery pack responsive to the operator input indicating that charging is to be initiated.

### TECHNICAL FIELD

The present disclosure relates generally to batteries and, for example, to a charging control system of a charging unit for battery packs.

### BACKGROUND

A machine may include one or more battery packs to provide power to components of the machine, such as lights, computer systems, and/or a motor, among other examples. A battery pack may be associated with a modular design that includes multiple battery modules. A battery module may include multiple battery cells. A state of charge (SOC) of a battery pack decreases with use of the machine, and the battery pack may be charged at the discretion of an operator of the machine. Accordingly, the operator may charge the battery pack sub-optimally, such as charging the battery pack too frequently, charging the battery pack before the battery pack is sufficiently drained, or allowing the battery pack to reach an extremely low charge level before charging, among other examples. Sub-optimal charging patterns can adversely affect a health of the battery pack, thereby decreasing a productivity and a useful life of the battery pack.

EP Application No. 4191743A1 (the '743 application) discloses an electric powered working machine that includes a secondary battery, a battery management unit that manages the secondary battery, and a controller that controls a normal charge or a diagnostic charge for the secondary battery. The controller determines whether to recommend the diagnostic charge or not based on an operation history of the secondary battery output from the battery management unit, and determines whether to execute the diagnostic charge or not based on a state of the secondary battery output from the battery management unit, an estimated charge period necessary for the diagnostic charge, and a site work plan including a work start time, when the diagnostic charge is determined to be recommended.

The controlled charging of the battery described by the '743 application is based on the operation history of the battery and a state of the battery. However, the '743 application does not disclose controlling charging of a battery based on an optimal charging behavior for the battery. Accordingly, techniques described by the '743 application may provide charging control according to sub-optimal charging patterns that can decrease a productivity and a useful life of the battery pack, as described above.

The charging control system of the present disclosure solves one or more of the problems set forth above and/or other problems in the art.

### SUMMARY

A charging control system may include contactors configured to control current flow in a charging unit and a controller. The controller may be configured to receive, from a battery management system of a battery pack prior to initiation of charging of the battery pack by the charging unit, charging information relating to the battery pack. The controller may be configured to identify, in accordance with a comparison of the charging information to charging guidelines, whether charging the battery pack is to comply with the charging guidelines. The controller may be configured to output, responsive to identifying that charging the battery pack is to violate the charging guidelines, a request for an operator input to indicate whether charging the battery pack is to be initiated. The controller may be configured to cause initiation of charging of the battery pack responsive to the operator input indicating that charging is to be initiated.

A method may include receiving, by a controller and prior to initiation of charging of a battery pack by a charging unit, charging information relating to the battery pack. The method may include identifying, by the controller and in accordance with a comparison of the charging information to charging guidelines, whether charging the battery pack is to comply with the charging guidelines. The method may include outputting, by the controller and responsive to identifying that charging the battery pack is to violate the charging guidelines, a request for an operator input to indicate whether charging the battery pack is to be initiated. The method may include causing, by the controller, initiation of charging of the battery pack responsive to the operator input indicating that charging is to be initiated.

A charging unit may include a display and a controller. The controller may be configured to receive, from a battery management system of a battery pack prior to initiation of charging of the battery pack by the charging unit, charging information relating to the battery pack. The controller may be configured to identify, in accordance with a comparison of the charging information to charging guidelines, whether charging the battery pack is to comply with the charging guidelines. The controller may be configured to output, responsive to identifying that charging the battery pack is to violate the charging guidelines and for presentation on the display, a request for an operator input to indicate whether charging the battery pack is to be initiated. The controller may be configured to cause initiation of charging of the battery pack responsive to the operator input indicating that charging is to be initiated.

### BRIEF DESCRIPTION OF THE DRAWINGS

FIG. 1 illustrates a perspective view an example machine charging system.

FIG. 2 is a diagram of an example charging control system.

FIG. 3 is a flowchart of an example process associated with charging a battery pack.

FIG. 4 is a flowchart of an example process associated with charging a battery pack.

### DETAILED DESCRIPTION

This disclosure relates to a charging control system, which is applicable to any machine that uses power provided by a battery. For example, the machine may perform an operation associated with an industry, such as mining, construction, farming, transportation, or any other industry.

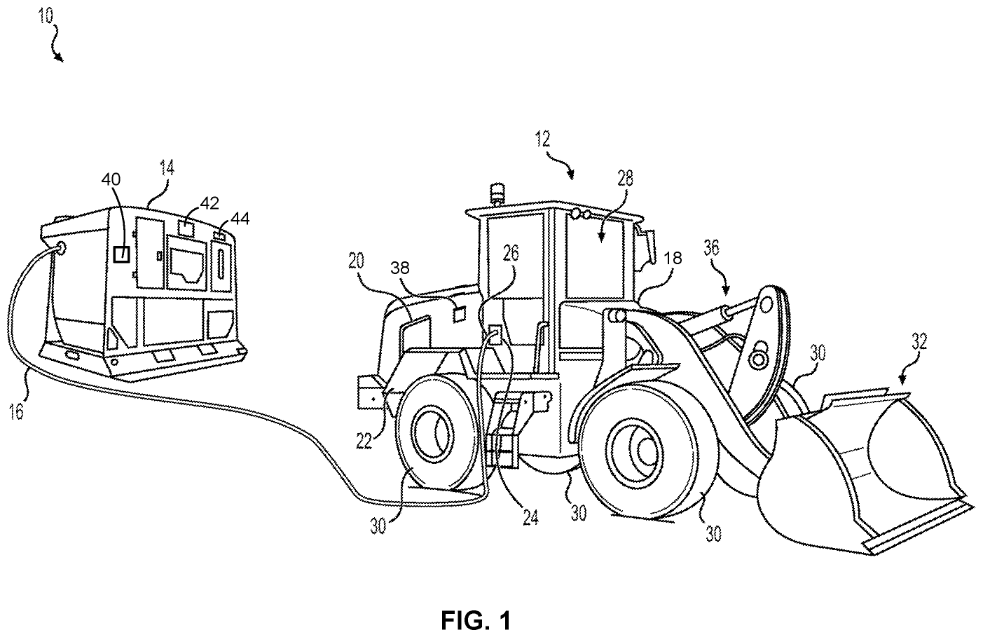

FIG. 1 illustrates a perspective view an example machine charging system 10. Machine charging system 10 includes a machine 12, a charging unit 14 (e.g., a power station), and one or more cables 16 that electrically connect the machine 12 and the charging unit 14.

The machine 12 may be a work machine. For example, the machine 12 may perform earth moving, excavation, or another operation associated with an industry, such as mining. As an example, as illustrated in FIG. 1, the machine 12 is a wheel loader. However, the machine 12 may be another type of machine, such as a compactor machine, a paving machine, a cold planer, a grading machine, a backhoe loader, a harvester, an excavator, a motor grader, a skid steer loader, a mining machine, a tractor, or a dozer, among other examples.

The machine 12 is an electric drive machine (e.g., an electric vehicle). For example, the machine 12 may be a fully electric vehicle or a partially electric vehicle (e.g., a hybrid vehicle that includes a battery and an engine). The machine 12 includes a frame 18. The machine 12 includes a battery pack 20 (e.g., one or more battery packs 20) supported by the frame 18. The battery pack 20 may power a motor 22, supported by the frame 18, and/or other components of machine 12, such as lights, electronics, temperature control systems, or the like. The battery pack 20 may include a housing containing one or more battery modules (e.g., connected in series and/or in parallel), and each battery module may include one or more battery cells (e.g., connected in series and/or in parallel). Each battery cell is associated with a chemistry type, such as lithium ion (Li-ion) (e.g., lithium ion polymer (Li-ion polymer), lithium iron phosphate (LFP), and/or nickel manganese cobalt (NMC)), nickel-metal hydride (NiMH), or nickel cadmium (NiCd), among other examples.

The battery pack 20 may include a battery management system (BMS) 38. The BMS 38 may include one or more controllers. For example, the BMS 38 may include a respective module controller for each battery module and/or a pack controller for the battery pack 20. The pack controller may have a respective communication link with each module controller. Moreover, the BMS 38 may include one or more sensors communicatively connected to the one or more controllers. A sensor may include a current sensor, a voltage sensor, a temperature sensor, and/or a humidity sensor, among other examples. The BMS 38 may be configured to control a start-up and/or a shut-down procedure of the battery pack 20, to re-balance battery cells and/or battery modules, to monitor a current and/or a voltage of a battery cell, a battery module, and/or the battery pack 20, to monitor an SOC of a battery cell, a battery module, and/or the battery pack 20, to monitor a resistance and/or an impedance of a battery cell, a battery module, and/or the battery pack 20, and/or to monitor a temperature and/or a humidity of a battery cell, a battery module, and/or the battery pack 20, among other examples.

The machine 12 may include a charger coupling 24. The charger coupling 24 may receive a mounting portion 26 of the cable 16 to connect the charging unit 14 to the machine 12. The charger coupling 24 and the mounting portion 26 may form a snap-fit connection or otherwise help couple the cable 16 to the machine 12. In one example, the charging unit 14 may deliver direct current (DC) to the battery pack 20 (e.g., via the connection of the mounting portion 26 of the cable 16 to the charger coupling 24).

The frame 18 may be supported by one or more ground engaging elements 30 that are driven by the motor 22. For example, the ground engaging elements 30 may include wheels, as shown, tracks, or the like. The machine 12 may include a cab 28 from which one or more operators may operate and/or control one or more operations of the machine 12. Additionally, the machine 12 may include one or more implements 32 (e.g., a bucket) coupled to and/or moveable relative to the frame 18 (e.g., via one or more hydraulic systems 36, including one or more sets of rods and cylinders that may be operated by the movement and/or pressurization of hydraulic fluid via one or more pumps). The battery pack 20 may power the implements 32 (e.g., via the hydraulic systems 36).

The charging unit 14 may be a portable charger device (e.g., movable around a worksite), or may be a permanently positioned charger device. The charging unit 14 is a power source. For example, the charging unit 14 may be a high-voltage power source (e.g., 500 volts (V) or more), or another voltage power source. The charging unit 14 (e.g., internal batteries of the charging unit 14) may be charged or otherwise powered via one or more connections to a power grid, generators or gensets, solar panels, wind turbines or wind power sources, hydroelectric sources, and/or another power source (e.g., a source of alternating current or direct current). The charging unit 14 may include a power output to couple the machine 12 to the charging unit 14 via the cable 16. In this way, the charging unit 14 may provide power to the battery pack 20 via the cable 16.

The cable 16 may include one or more conductive cables or wires configured to electrically connect and/or communicatively connect the charging unit 14 and the machine 12. The cable 16 may be configured to carry a high voltage, such as 500 V, or another voltage from the charging unit 14 to the machine 12. In some examples, the charging unit 14 may include the cable 16 (e.g., the cable 16 may be fixedly coupled to an output of the charging unit 14). Alternatively, the charging unit 14 may include a charger coupling (not shown) to provide removable coupling of the cable 16 to the charging unit 14, in a similar manner as described above.

The charging unit 14 may include a controller 40 (e.g., one or more controllers). The controller 40 may be configured (e.g., through instructions, software, firmware, or the like) to perform one or more operations described herein in connection with controlling the charging unit 14. The controller 40 may be coupled to a display 42 (e.g., a touchscreen display) of the charging unit 14 and/or one or more operator controls 44 of the charging unit 14.

The controller 40 may include one or more processors and/or one or more memories. A processor may include a central processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. In some implementations, the processor may include one or more processors capable of being programmed to perform one or more operations or processes described elsewhere herein. A memory may include volatile and/or nonvolatile memory. For example, the memory may include random access memory (RAM), read only memory (ROM), and/or another type of memory (e.g., a flash memory, a magnetic memory, and/or an optical memory). The memory may include internal memory (e.g., RAM, ROM, or a hard disk drive) and/or removable memory (e.g., removable via a universal serial bus connection). The memory may be a non-transitory computer-readable medium. The memory may store information, one or more instructions, and/or software (e.g., one or more software applications) related to the operation of the battery pack 20, a battery module, and/or a battery cell. The memory may include one or more memories that are coupled (e.g., communicatively coupled) to the processor, such as via a bus. Communicative coupling between a processor and a memory may enable the processor to read and/or process information stored in the memory and/or to store information in the memory.

As indicated above, FIG. 1 is provided as an example. Other examples may differ from what is described with regard to FIG. 1.

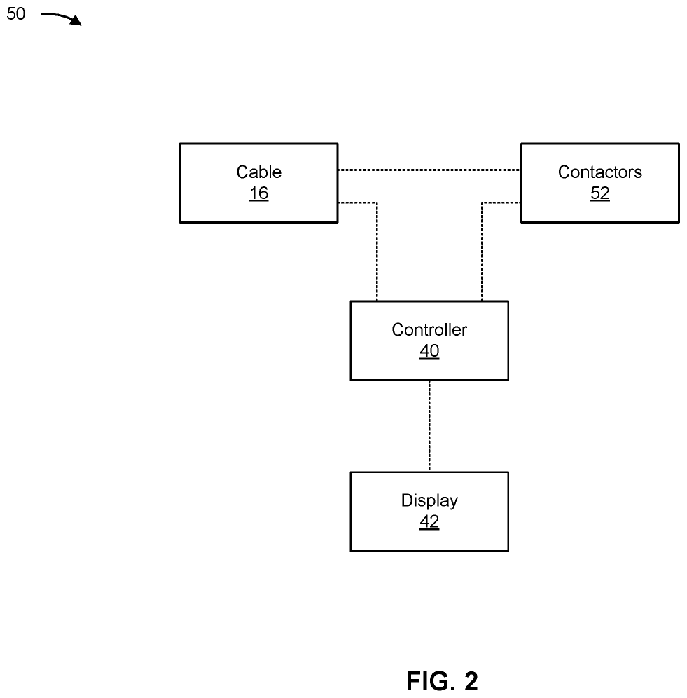

FIG. 2 is a diagram of an example charging control system 50. As shown, the charging control system 50 may include the controller 40, the display 42, contactors 52, and/or the cable 16. For example, the controller 40 may have a communication link with the display 42, the controller 40 may have electrical connections and/or communication links with the cable 16 and the contactors 52, and the cable 16 may have an electrical connection with the contactors 52. The charging control system 50 may be configured to control charging of the battery pack 20 of the machine 12 by the charging unit 14.

When the battery pack 20 is connected to the charging unit 14 via the cable 16, the controller 40 and/or the BMS 38 may detect the charging connection (e.g., based on detecting current in one or more monitoring contacts). Furthermore, when the battery pack 20 is connected to the charging unit 14 via the cable 16 (e.g., when the charging connection is detected), the controller 40 and the BMS 38 may exchange information (e.g., in signaling of a handshake procedure) prior to initiation of charging of the battery pack 20 by the charging unit 14. For example, the controller 40 may receive, from the BMS 38 (e.g., after a connection to the charging unit 14 is made for the battery pack 20, but prior to initiating charging of the battery pack 20), identification information and/or charging information. In some examples, the controller 40 may indicate, to the BMS 38, a request for the identification information and/or the charging information, and the controller 40 may receive the identification information and/or the charging information responsive to the request.

The identification information may indicate an identifier for the battery pack 20 (e.g., a battery pack serial number), specifications for the battery pack 20 (e.g., a manufacturer of the battery pack 20, a model number of the battery pack 20, a power capacity of the battery pack 20, an age of the battery pack 20, or the like), and/or an identifier for the machine 12 (e.g., a machine serial number), among other examples. The charging information may relate to the battery pack 20. The charging information may relate to a state of the battery pack 20 at a time when the battery pack 20 is connected to the charging unit 14. The charging information may indicate a current SOC of the battery pack 20, a current temperature of the battery pack 20, or the like. In some implementations, the controller 40 may use the charging information in connection with operations to assess whether charging of the battery pack 20 is to be initiated, as described herein, if the identification information indicates that a manufacturer of the battery pack 20 is a particular manufacturer. Otherwise, if the manufacturer of the battery pack 20 is not the particular manufacturer, the controller 40 may cause initiation of charging of the battery pack 20 without using the charging information.

The controller 40 may identify, in accordance with the identification information (e.g., the identifier of the battery pack 20), whether historical charging information relating to the battery pack 20 is available. For example, the controller 40 may retrieve the historical charging information relating to the battery pack 20 using the identification information (e.g., the identifier of the battery pack 20). As an example, the controller 40 may reference the identification information against a set of historical charging information (e.g., in a database) in order to retrieve the historical charging information relating to the battery pack 20, and/or the controller 40 may transmit the identification information in a request to a service that provides historical charging information and receive the historical charging information relating to the battery pack 20 from the service. The historical charging information relating to the battery pack 20 being available indicates that the battery pack 20 has been charged before. The historical charging information relating to the battery pack 20 not being available indicates that the battery pack 20 has not been charged before (or that no record of a previous charging was made for the battery pack 20).

The set of historical charging information may be stored locally at the charging unit 14, or the set of historical charging information may be stored in another device (e.g., a cloud device) and the controller 40 may be configured to communicate with the other device. When stored locally at the charging unit 14, the set of historical charging information may relate only to chargings performed at the charging unit 14 and/or may relate to chargings performed at other charging units 14. For example, multiple charging units 14 may communicate with each other to exchange historical charging information captured at each of the charging units 14, or historical charging information captured at the multiple charging units 14 may be communicated to a central node that distributes the historical charging information to the multiple charging units 14.

If the historical charging information relating to the battery pack 20 is not available (e.g., this is a first charging of the battery pack 20), then the controller 40 may cause initiation of charging of the battery pack 20, as described below. If the historical charging information relating to the battery pack 20 is available, then the controller 40 may determine whether charging of the battery pack 20 should be initiated, as described herein. The historical charging information may indicate data relating to one or more previous charging instances for the battery pack 20. For example, data for a previous charging instance may indicate an initial SOC and/or temperature of the battery pack 20 before beginning the previous charging instance, a final SOC and/or temperature of the battery pack 20 after completing the previous charging instance, and/or a timestamp of the previous charging instance (e.g., when the previous charging instance was initiated and/or completed), among other examples.

The controller 40 may be provisioned with (e.g., the controller 40 may store in a memory) charging guidelines. The charging guidelines may indicate one or more best practices for charging battery packs. The best practices may be practices for charging battery packs that, if followed, would increase a useful life of the battery packs (e.g., relative to if the best practices were not followed). For example, the charging guidelines may indicate a minimum SOC above which a battery pack should be charged, a maximum SOC below which a battery pack should be charged, an SOC range in which a battery pack should be charged, a minimum battery temperature above which a battery pack should be charged, a maximum battery temperature below which a battery pack should be charged, a battery temperature range in which a battery pack should be charged, and/or a frequency between chargings of a battery pack (e.g., a delay that should be observed between chargings of a battery pack), among other examples. In some implementations, the charging guidelines may be generated (e.g., by the controller 40) using historical charging data and historical battery life data as an input to an artificial intelligence model.

In some implementations, the controller 40 may select particular charging guidelines (e.g., from a set of charging guidelines) relevant to the battery pack 20. For example, the selected charging guidelines may be particular to a model of the battery pack 20, a power capacity of the battery pack 20, and/or an age of the battery pack 20, among other examples. Additionally, or alternatively, the controller 40 may adjust baseline charging guidelines in accordance with a model of the battery pack 20, a power capacity of the battery pack 20, and/or an age of the battery pack 20, among other examples.

The controller 40 may compare the charging information to the charging guidelines (e.g., the selected charging guidelines and/or the adjusted charging guidelines). For example, the controller 40 may compare the charging information to the charging guidelines responsive to the historical charging information relating to the battery pack 20 being available (e.g., this is not a first charging of the battery pack 20). As one example, the controller 40 may compare the charging information to the charging guidelines to identify whether the current SOC of the battery pack 20 is above the minimum SOC, below the maximum SOC, and/or within the SOC range. As another example, the controller 40 may compare the charging information to the charging guidelines to identify whether the current temperature of the battery pack 20 is above the minimum battery temperature, below the maximum temperature, and/or within the battery temperature range. Accordingly, the controller 40 may identify, in accordance with a comparison of the charging information to charging guidelines, whether charging the battery pack 20 (e.g., at a current time) complies with the charging guidelines (e.g., whether the charging would align with the best practices).

The controller 40 may further compare the historical charging information to the charging guidelines. For example, the controller 40 may compare the historical charging information to the charging guidelines to identify whether an elapsed time since a previous charging instance of the battery pack 20 adheres to the frequency between chargings. Accordingly, the controller 40 may identify, in accordance with a comparison of the historical charging information to charging guidelines, whether charging the battery pack 20 (e.g., at a current time) complies with the charging guidelines (e.g., whether the charging would align with the best practices).

Responsive to identifying that charging the battery pack 20 would comply with the charging guidelines, the controller 40 may cause initiation of charging of the battery pack 20, as described below. Otherwise, responsive to identifying that charging the battery pack 20 would violate the charging guidelines, the controller 40 may output an indication that charging the battery pack 20 would violate the charging guidelines. For example, the controller 40 outputting the indication may cause presentation, on the display 42, of information indicating that charging the battery pack 20 would violate the charging guidelines (e.g., indicating that the best practices would be violated). In some examples, the information may indicate one or more charging guidelines that would be violated by charging the battery pack 20. In some examples, the controller 40 may also output information indicating whether the historical charging information complies with the charging guidelines. For example, the controller 40 may output an indication of, and the information presented on the display 42 may also indicate, one or more historical violations of the charging guidelines.

Additionally, responsive to identifying that charging the battery pack 20 would violate the charging guidelines, the controller 40 may cause transmission, of a notification indicating a violation, offboard the charging unit 14. For example, the notification may be received at a user device of a supervisor associated with the machine 12. Additionally, or alternatively, the controller 40 may determine whether the current violation of the charging guidelines, in combination with historical violations of the charging guidelines indicated by the historical charging information, indicates repeat violations (e.g., a threshold quantity of repeat violations) of the charging guidelines, and the controller 40 may cause transmission of the notification responsive to determining the repeat violations. The repeat violations may be tallied with respect to a single operator of the machine 12 or multiple operators of the machine 12. For example, the historical charging information may indicate an identity of an operator of the machine 12 for each previous charging instance. Accordingly, the controller 40 may cause transmission of the notification responsive to determining repeat violations (e.g., a threshold quantity of repeat violations) associated with a single operator of the machine 12 (e.g., that is currently operating the machine 12). Thus, the notification may indicate the identity of the operator.

Furthermore, responsive to identifying that charging the battery pack 20 would violate the charging guidelines, the controller 40 may output a request for a first operator input to indicate whether charging is to be initiated. For example, the controller 40 outputting the request may cause presentation, on the display 42, of information requesting an operator to input whether charging is to be initiated. As an example, the information may include one or more virtual buttons that can be selected by an operator to indicate whether charging should be initiated. In some examples, the controller 40 may output the request for the first operator input when the charging information indicates that the current SOC of the battery pack at least meets a minimum SOC, but not when the charging information indicates that the current SOC of the battery pack is below the minimum SOC (e.g., because charging should be initiated when the current SOC is below the minimum SOC even if doing so violates the charging guidelines).

Thus, after informing the operator that charging the battery pack 20 would violate the charging guidelines, the operator may be given the option to proceed with charging the battery pack 20 anyway. In some implementations, the charging unit 14 may require an authentication input (e.g., from a supervisor or the like) in order to proceed in violation of the charging guidelines. The authentication input may include a password, a passcode, a physical key, a key fob, or the like. Accordingly, the controller 40 may allow charging of the battery pack 20 to proceed in violation of the charging guidelines based on authenticating the authentication input.

Responsive to the first operator input indicating that charging is to be initiated, the controller 40 may output information (e.g., to cause the information to be presented on the display 42) indicating a battery life prediction (e.g., a remaining useful life prediction) for the battery pack 20 to result from charging the battery pack 20 in violation of the charging guidelines. The controller 40 may determine a battery life prediction using a prediction algorithm that factors in charging behavior (e.g., an SOC at initiation of charging, a charging frequency, or the like) and/or using a machine learning model that outputs the battery life prediction using an input of charging behavior. The battery life prediction may be based on, or adjusted from a baseline prediction based on, a model of the battery pack 20, a power capacity of the battery pack 20, and/or an age of the battery pack 20.

Furthermore, responsive to the first operator input indicating that charging is to be initiated, the controller 40 may output a request for a second operator input to indicate whether charging is to be initiated, in a similar manner as described above. Thus, after informing the operator of the effect on battery life that would result from charging the battery pack 20 in violation of the charging guidelines, the operator may be given the option to proceed with charging the battery pack 20 anyway. As described above, the charging unit 14 may require an authentication input (e.g., from a supervisor or the like) in order to proceed in violation of the charging guidelines.

Responsive to the operator input (e.g., the first operator input and/or the second operator input) indicating that charging is to be initiated, the controller 40 may cause initiation of charging of the battery pack 20. To cause initiation of charging of the battery pack 20, the controller 40 may cause the contactors 52 to close (e.g., the contactors 52 may have a normally-open configuration). For example, the controller 40 may output a control signal to the contactors 52 to cause the contactors 52 to close. The contactors 52 may be electrical switching devices configured to control current flow in the charging unit 14. Thus, when the contactors 52 are closed, current may flow in the charging unit 14 to provide charging of the battery pack 20 via the cable 16. Conversely, when the contactors 52 are open, current is prevented from flowing in the charging unit 14 to charge the battery pack 20.

Responsive to the operator input (e.g., the first operator input and/or the second operator input) indicating that charging is not to be initiated, the controller 40 may output information (e.g., to cause the information to be presented on the display 42). The information may indicate a recommendation of an SOC of the battery pack 20 at which to perform charging of the battery pack 20 and/or a recommendation of a frequency between chargings of the battery pack 20 that is to be used. The recommendation of the SOC and/or the recommendation of the frequency between chargings may be based on the charging guidelines. In some examples, the recommendation of the SOC and/or the recommendation of the frequency between chargings may be based on, or adjusted from baseline recommendations based on, a model of the battery pack 20, a power capacity of the battery pack 20, and/or an age of the battery pack 20. Additionally, or alternatively, the controller 40 may determine, and the information may indicate, a battery life prediction (e.g., a remaining useful life prediction) for the battery pack 20 to result from charging the battery pack 20 in accordance with the recommendation(s). Furthermore, responsive to the operator input (e.g., the first operator input and/or the second operator input) indicating that charging is not to be initiated, the controller 40 may cause restriction of charging of the battery pack 20. To cause restriction of charging of the battery pack 20, the controller 40 may cause the contactors 52 to remain open (or to open, if the contactors have a normally-closed configuration).

Following initiation of the charging (e.g., in any of the scenarios described herein for initiating charging) or restriction of the charging, the controller 40 may generate a log entry (e.g., generate historical charging data relating to the battery pack 20) indicating an initial SOC of the battery pack 20 prior to charging the battery pack 20 and a final SOC of the battery pack 20 after completing charging of the battery pack 20. Completion of charging of the battery pack 20 may include a scenario in which the battery pack 20 is actually charged (e.g., the SOC of the battery pack 20 is increased) or a scenario in which the battery pack 20 was connected to the charging unit 14 but not actually charged (e.g., because an operator input indicated that charging was not to be initiated). The log entry may further indicate a timestamp associated with the charging (or the attempt to charge), a temperature of the battery pack 20, or the like. Furthermore, following initiation of the charging (e.g., in any of the scenarios described herein for initiating charging) or restriction of the charging, the controller 40 may output information (e.g., to cause the information to be presented on the display 42) indicating a list of previous chargings of the battery pack 20 (e.g., which may now include the current charging that was completed) and whether those previous chargings complied with or violated the charging guidelines, thereby providing an overview of how the battery pack 20 is being treated over time.

As indicated above, FIG. 2 is provided as an example. Other examples may differ from what is described with regard to FIG. 2.

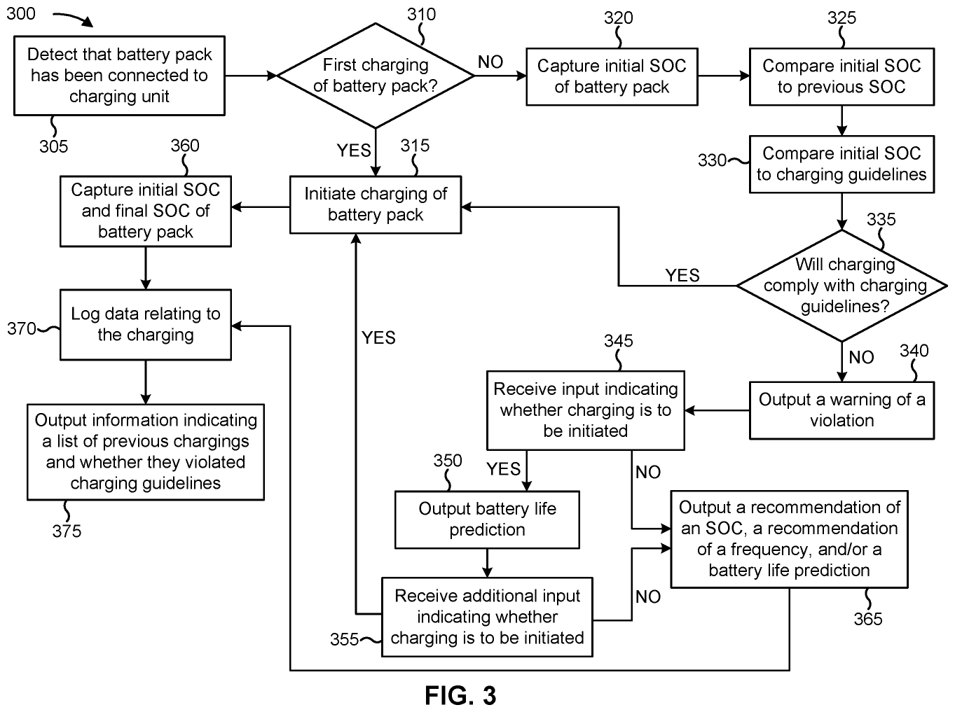

FIG. 3 is a flowchart of an example process 300 associated with charging a battery pack. One or more process blocks of FIG. 3 may be performed by a controller (e.g., controller 40). Additionally, or alternatively, one or more process blocks of FIG. 3 may be performed by another device or a group of devices separate from or including the controller, such as another device or component that is internal or external to charging unit 14.

As shown in FIG. 3, process 300 may include detecting that a battery pack has been connected to a charging unit (block 305), as described herein. For example, the battery pack may be connected to the charging unit to initiate charging of the battery pack by the charging unit. Process 300 may include identifying whether charging of the battery pack is a first charging of the battery pack (block 310), as described herein. Based on identifying that the charging is a first charging of the battery pack (block 310—YES), process 300 may include initiating charging of the battery pack (block 315), as described herein.

Based on identifying that the charging is not a first charging of the battery pack (block 310—NO), process 300 may include capturing an initial SOC of the battery pack (block 320), as described herein. For example, the initial SOC may be indicated in charging information transmitted by a BMS of the battery pack, as described herein. Process 300 may include comparing the initial SOC to a previous SOC of the battery pack (block 325). For example, comparing the initial SOC to the previous SOC may enable the identification of trends in a charging behavior associated with the battery pack. Process 300 may include comparing the initial SOC to charging guidelines (block 330), as described herein.

Process 300 may include identifying whether charging the battery pack will comply with the charging guidelines (block 335), as described herein. Based on identifying that the charging will comply with the charging guidelines (block 335—YES), process 300 may include initiating charging of the battery pack (block 315), as described herein. Based on identifying that the charging will not comply with the charging guidelines (block 335—NO), process 300 may include outputting a warning of a violation of the charging guidelines (block 340), as described herein.

Process 300 may include receiving an input indicating whether charging is to be initiated (block 345), as described herein. Based on the input indicating that charging is to be initiated (block 345—YES), process 300 may include outputting a battery life prediction to result from charging the battery pack in violation of the charging guidelines (block 350), as described herein. Process 300 may include receiving an additional input indicating whether charging is to be initiated (block 355), as described herein. Based on the additional input indicating that charging is to be initiated (block 355—YES), process 300 may include initiating charging of the battery pack (block 315), as described herein. In some examples, charging may be initiated (e.g., in violation of the charging guidelines) if an authentication input (e.g., a password, a passcode, a physical key, a key fob, or the like) is provided with (e.g., concurrently or sequentially) the additional input indicating that charging is to be initiated. Process 300 may include capturing an initial SOC of the battery pack (if not already captured) and a final SOC of the battery pack (e.g., after charging) (block 360), as described herein.

Based on the input indicating that charging is not to be initiated (block 345—NO) and/or the additional input indicating that charging is not to be initiated (block 355—NO), process 300 may include outputting a recommendation of an SOC at which to perform charging, a recommendation of a frequency between chargings, and/or a battery life prediction to result from following the recommendation(s) (block 365), as described herein. Process 300 may include logging data relating to the charging (or the attempt to charge) (block 370), as described herein. Process 300 may include outputting information indicating a list of previous chargings and whether they violated the charging guidelines (block 375), as described herein.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

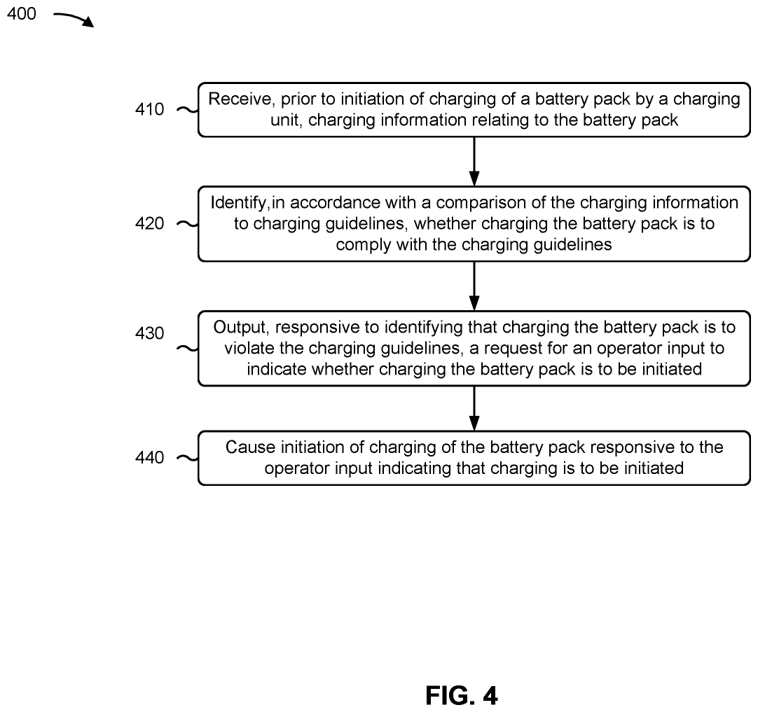

FIG. 4 is a flowchart of an example process 400 associated with charging a battery pack. One or more process blocks of FIG. 4 may be performed by a controller (e.g., controller 40). Additionally, or alternatively, one or more process blocks of FIG. 4 may be performed by another device or a group of devices separate from or including the controller, such as another device or component that is internal or external to charging unit 14.

As shown in FIG. 4, process 400 may include receiving, prior to initiation of charging of a battery pack by a charging unit, charging information relating to the battery pack (block 410). For example, the controller may receive, prior to initiation of charging of a battery pack by a charging unit, charging information relating to the battery pack, as described above. The charging information may indicate a current SoC of the battery pack.

As further shown in FIG. 4, process 400 may include identifying, in accordance with a comparison of the charging information to charging guidelines, whether charging the battery pack is to comply with the charging guidelines (block 420). For example, the controller may identify, in accordance with a comparison of the charging information to charging guidelines, whether charging the battery pack is to comply with the charging guidelines, as described above. The charging guidelines may indicate one or more of a minimum SoC for charging the battery pack, a maximum SoC for charging the battery pack, or a frequency between chargings of the battery pack.

As further shown in FIG. 4, process 400 may include outputting, responsive to identifying that charging the battery pack is to violate the charging guidelines, a request for an operator input to indicate whether charging the battery pack is to be initiated (block 430). For example, the controller may output, responsive to identifying that charging the battery pack is to violate the charging guidelines, a request for an operator input to indicate whether charging the battery pack is to be initiated, as described above.

Process 400 may include outputting, responsive to the operator input indicating that charging of the battery pack is not to be initiated, information indicating a recommendation of an SoC of the battery pack at which to perform charging of the battery pack or a frequency between chargings of the battery pack that is to be used, and a battery life prediction for the battery pack to result from charging the battery pack in accordance with the recommendation. Process 400 may include outputting, responsive to the operator input indicating that charging of the battery pack is to be initiated, information indicating a battery life prediction for the battery pack to result from charging the battery pack in violation of the charging guidelines. Process 400 may include outputting, in connection with outputting the information indicating the battery life prediction for the battery pack to result from charging the battery pack in violation of the charging guidelines, an additional request for an additional operator input to indicate whether charging of the battery pack is to be initiated.

As further shown in FIG. 4, process 400 may include causing initiation of charging of the battery pack responsive to the operator input indicating that charging is to be initiated (block 440). For example, the controller may cause initiation of charging of the battery pack responsive to the operator input indicating that charging is to be initiated, as described above. In some examples, causing initiation of charging of the battery pack may be responsive to the operator input and the additional operator input indicating that charging is to be initiated.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

The charging control system described herein may be used with any charging unit, or charger, that provides battery charging. For example, the charging control unit may be used with a charging unit that provides charging of battery packs of work machines. In general, a battery pack may be charged at the discretion of an operator of a machine. Accordingly, the operator may charge the battery pack sub-optimally, such as charging the battery pack too frequently, charging the battery pack before the battery pack is sufficiently drained, or allowing the battery pack to reach an extremely low charge level before charging, among other examples. Sub-optimal charging patterns can adversely affect a health of the battery pack, thereby decreasing a productivity and a useful life of the battery pack.

The charging control system described herein is useful for improving charging patterns for a battery pack. In particular, the charging control system may use charging information (e.g., SOC, charging frequency, or the like) associated with a battery pack to monitor whether charging behavior for the battery pack complies with charging guidelines (e.g., that indicate charging best practices). In this way, the charging control system may allow charging that complies with the charging guidelines, but deter charging that violates the charging guidelines. Accordingly, the charging control system may improve an overall health of the battery pack, thereby improving the battery pack's productivity and useful life.

What is claimed is:

1. A charging control system, comprising:
contactors configured to control current flow in a charging unit; and
a controller configured to:
receive, from a battery management system of a battery pack prior to initiation of charging of the battery pack by the charging unit, charging information relating to the battery pack;
identify, in accordance with a comparison of the charging information to charging guidelines, whether charging the battery pack is to comply with the charging guidelines;
output, responsive to identifying that charging the battery pack is to violate the charging guidelines, a request for an operator input to indicate whether charging the battery pack is to be initiated; and
cause initiation of charging of the battery pack responsive to the operator input indicating that charging is to be initiated.

2. The charging control system of claim 1, wherein the charging information indicates a state of charge of the battery pack.

3. The charging control system of claim 1, wherein the controller, to receive the charging information, is configured to receive the charging information and an identifier of the battery pack.

4. The charging control system of claim 3, wherein the controller is further configured to:
retrieve, using the identifier of the battery pack, historical charging information relating to the battery pack; and
output information indicating whether the historical charging information complies with the charging guidelines.

5. The charging control system of claim 3, wherein the controller is further configured to:
identify, in accordance with the identifier of the battery pack, whether historical charging information relating to the battery pack is available,
wherein the comparison of the charging information to the charging guidelines is responsive to the historical charging information being available.

6. The charging control system of claim 1, wherein the controller is further configured to:
output, responsive to the operator input indicating that charging of the battery pack is to be initiated, information indicating a battery life prediction for the battery pack to result from charging the battery pack in violation of the charging guidelines.

7. The charging control system of claim 6, wherein the controller is further configured to:
output an additional request for an additional operator input to indicate whether charging of the battery pack is to be initiated,
wherein the controller is configured to cause initiation of charging of the battery pack responsive to the operator input and the additional operator input indicating that charging is to be initiated.

8. The charging control system of claim 1, wherein the controller, to cause initiation of charging of the battery pack, is configured to:
cause the contactors to close.

9. The charging control system of claim 1, wherein the controller is further configured to:
cause restriction of charging of the battery pack responsive to the operator input indicating that charging of the battery pack is not to be initiated.

10. The charging control system of claim 9, wherein the controller, to cause restriction of charging of the battery pack, is configured to:
cause the contactors to remain open.

11. A method, comprising:
receiving, by a controller and prior to initiation of charging of a battery pack by a charging unit, charging information relating to the battery pack;
identifying, by the controller and in accordance with a comparison of the charging information to charging guidelines, whether charging the battery pack is to comply with the charging guidelines;
outputting, by the controller and responsive to identifying that charging the battery pack is to violate the charging guidelines, a request for an operator input to indicate whether charging the battery pack is to be initiated; and
causing, by the controller, initiation of charging of the battery pack responsive to the operator input indicating that charging is to be initiated.

12. The method of claim 11, wherein the charging guidelines indicate one or more of:
a minimum state of charge for charging the battery pack,
a maximum state of charge for charging the battery pack, or
a frequency between chargings of the battery pack.

13. The method of claim 11, further comprising:
outputting, responsive to the operator input indicating that charging of the battery pack is not to be initiated, information indicating:
a recommendation of a state of charge of the battery pack at which to perform charging of the battery pack or a frequency between chargings of the battery pack that is to be used, and
a battery life prediction for the battery pack to result from charging the battery pack in in accordance with the recommendation.

14. The method of claim 11, further comprising:
outputting, responsive to the operator input indicating that charging of the battery pack is to be initiated, information indicating a battery life prediction for the battery pack to result from charging the battery pack in violation of the charging guidelines.

15. The method of claim 14, further comprising:
outputting an additional request for an additional operator input to indicate whether charging of the battery pack is to be initiated,
wherein causing initiation of charging of the battery pack is responsive to the operator input and the additional operator input indicating that charging is to be initiated.

16. A charging unit, comprising:
a display; and
a controller configured to:
receive, from a battery management system of a battery pack prior to initiation of charging of the battery pack by the charging unit, charging information relating to the battery pack;
identify, in accordance with a comparison of the charging information to charging guidelines, whether charging the battery pack is to comply with the charging guidelines;
output, responsive to identifying that charging the battery pack is to violate the charging guidelines and for presentation on the display, a request for an operator input to indicate whether charging the battery pack is to be initiated; and
cause initiation of charging of the battery pack responsive to the operator input indicating that charging is to be initiated.

17. The charging unit of claim 16, wherein the controller is further configured to:
output, responsive to identifying that charging the battery pack is to violate the charging guidelines, an indication that charging the battery pack is to violate the charging guidelines.

18. The charging unit of claim 16, wherein the controller is further configured to:
cause initiation of charging of the battery pack responsive to identifying that charging the battery pack is to comply with the charging guidelines.

19. The charging unit of claim 16, wherein the controller is further configured to:
output, responsive to the operator input indicating that charging of the battery pack is to be initiated, information indicating a battery life prediction for the battery pack to result from charging the battery pack in violation of the charging guidelines; and
output an additional request for an additional operator input to indicate whether charging of the battery pack is to be initiated,
wherein the controller is configured to cause initiation of charging of the battery pack responsive to the operator input and the additional operator input indicating that charging is to be initiated.

20. The charging unit of claim 16, further comprising:
a cable configured to electrically connect the battery pack to the charging unit.
